(19) United States
(12) Patent Application Publication
(10) Pub. No.: US 2026/0085737 A1
(43) Pub. Date: Mar. 26, 2026

(54) FRICTION MATERIAL COMPOSITION AND FABRICATING ARTICLES THEREFROM

(71) Applicant: GHARDA CHEMICALS LIMITED, Dombivli (IN)

(72) Inventors: Prakash D. TRIVEDI, Dombivli (IN); Jayashree BIJWE, New Delhi (IN); Bhaskaranand BHATT, New Delhi (IN); Umesh MARATHE, New Delhi (IN)

(21) Appl. No.: 19/109,721

(22) PCT Filed: Aug. 9, 2023
(86) PCT No.: PCT/IB2023/058046

§ 371 Date: Mar. 7, 2025

(30) Foreign Application Priority Data
Sep. 8, 2022 (IN) 202221051475

(51) Int. Cl. F16D 69/02

(52) U.S. Cl. CPC F16D 69/026; F16D 69/023; F16D 2200/0086; F16D 2200/0095

(57) ABSTRACT

The present disclosure relates to a friction material composition comprising reactive poly aryl ether ketone (R-PAEK) as a binder. The present disclosure further relates to a process for the preparation of a friction material composition. Furthermore, the present disclosure relates to a process for the fabrication of an article by using the friction material composition. The friction material composition of the present disclosure does not require post curing while manufacturing brake pads. Further, the article fabricated by using the friction material composition of the present disclosure has longer shelf life and do not evolve noxious by-products and possesses superior physical and tribological properties.

### FIELD

The present disclosure relates to friction material composition and a process for its preparation. The present disclosure further relates to a process for the fabrication of an article by using the friction material composition.

### BACKGROUND

The background information herein below relates to the present disclosure but is not necessarily prior art.

Different types of phenolic resins are used as a polymeric matrix/binder in friction materials (FMs) owing to their low cost and easy availability. However, the phenolic resins have various drawbacks like poor shelf life posing constraints to storage and transportation. Further, the phenolic resins suffer from the drawback of emission of noxious volatile by-products such as formaldehyde, ammonia, and the like, during molding leading to environmental issues as well as leading to cracks and voids. Still further, the phenolic resins employ corrosive chemicals during their synthesis. Another problem with phenolic resins is in the form of shrinkage of the part after molding and need for an additional curing agent which adds to the cost of the product.

Recently, an alkaline siliceous solution and aluminosilicate powder have been combined to produce geopolymer, which has been employed as a binder in place of phenolic resin in Cu-free non-asbestos organic (NAO) friction materials. However, wear resistance of the friction material decreased after employing this geopolymer in the brake pads.

Further, a friction material composition with a hydraulic binder, such as Portland cement, is known in the prior art. However, when water is used to solidify the binder, it may cause corrosion on metallic elements.

There is, therefore, felt a need to provide a friction material composition that mitigates the aforestated drawbacks or at least provides a useful alternative.

### OBJECTS

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a friction material composition.

Another object of the present disclosure is to provide a friction material composition comprising reactive polyaryl ether ketone (R-PAEK) resin as a binder that replaces the conventional phenolic resin.

Still another object of the present disclosure is to provide a friction material composition that does not require post curing during manufacturing of the brake pads.

Yet another object of the present disclosure is to provide a friction material composition for manufacturing brake-pads with superior physical and tribological properties.

Still another object of the present disclosure is to provide a simple and efficient process for the preparation of a friction material composition.

Yet another object of the present disclosure is to provide a process for the fabrication of an article by using the friction material composition.

Other objects and advantages of the present disclosure will be more apparent from the following description, which is not intended to limit the scope of the present disclosure.

### SUMMARY

The present disclosure relates to a friction material composition comprising a first mixture and a second mixture. The first mixture includes 2 mass % to 25 mass % of at least one fibrous material, 2 mass % to 25 mass % of at least one friction modifier and 8 mass % to 45 mass % of at least one functional filler. The second mixture includes 13 mass % to 25 mass % of at least one inert filler and 3 mass % to 15 mass % of at least one binder. The mass % of each component is with respect to the total mass of the friction material composition. The mass ratio of the first mixture to the second mixture is in the range of 1:0.1 to 1:0.5.

Further, the present disclosure relates to a process for the preparation of a friction material composition. The process comprises the step of mixing at least one fibrous material with at least one inert filler at a first predetermined stirring speed for a first predetermined time period to obtain a first mixture. Separately, at least one friction modifier is mixed with at least one functional filler and at least one binder at a second predetermined stirring speed for a second predetermined time period to obtain a second mixture. The first mixture and the second mixture are mixed at a third predetermined stirring speed for a third predetermined time period to obtain the friction material composition.

Still further, the present disclosure relates to a process for the fabrication of an article by using the friction material composition. The process comprises the step of drying the friction material composition at a temperature in the range of 60° C. to 90° C. to obtain a dried friction material composition. The dried friction material composition is preformed at a pressure in the range of 1 MPa to 3 MPa to obtain at least one preform. The preform is placed into a mold cavity followed by heating to a temperature in the range of 400° C. to 450° C. for a time period in the range of 2 minutes to 10 minutes to obtain a heated preform, wherein the mold cavity is fixed into a compression molding machine and preloaded with adhesive-applied backplates. A pressure in the range of 80 bars to 120 bars with 5 cycles of intermittent breathings is applied to the heated preform for a time period in the range of 5 hours to 10 hours to obtain a fabricated article. The fabricated article is cooled to a temperature in the range of 20° C. to 30° C. followed by removing the fabricated article from the mold cavity.

### BRIEF DESCRIPTION OF THE ACCOMPANYING DRAWING

The present disclosure will now be described with the help of the accompanying drawing, in which:

FIG. 1a illustrates a differential scanning calorimetric (DSC) scan of reactive polyaryl ether ketone (R-PAEK) resin powder; and

FIG. 1b illustrates a differential scanning calorimetric (DSC) scan of phenolic resin powder.

### DETAILED DESCRIPTION

The present disclosure relates to friction material composition, a process for the preparation of a friction material composition and a process for the fabrication of an article by using the friction material composition.

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

Friction material (FM) should perform essential functions viz. regeneration of a similar range of coefficient of friction (u) irrespective of speed, pressure, temperature maintaining constant stopping distance, less emission of noise-vibration, low wear even after intense brake operations and the like. The target properties are achieved by tailoring the different constituents present in friction material composition classified into four categories viz. binder, fibers, functional fillers, and space fillers. Among these, the binder is recognised as the vital ingredient of friction material composition as it holds together the amalgamation of reinforcements and thus acts as custodian of other constituents.

Conventionally, phenolic resins are used as binders in friction materials. However, the phenolic resins have a limited shelf life leading to transport and storage problems and additional costs. Further, synthesis of phenolic resins employ corrosive chemicals and noxious volatile by-products such as formaldehyde, ammonia and the like are emitted during molding of phenolic resins leading to environmental issues as well as cracks and voids in the obtained resin. Another problem with phenolic resins is shrinkage of the part after molding. Still further, additional curing agent is added before supplying the phenolic resin to the users by the manufacturers, which also adds to the cost of the resin.

Therefore, the present disclosure provides reactive polyetherketone (R-PAEK) resin based friction material composition with sustainability, better performance and eco-friendly characteristics.

The present disclosure further provides a process for the preparation of the friction material composition. Furthermore, the present disclosure provides a fabrication process by using reactive polyarylether ketone (R-PAEK) based friction material composition.

In a first aspect, the present disclosure provides a friction material composition comprising:
(i) a first mixture that includes:
   2 mass % to 25 mass % of at least one fibrous material;
   2 mass % to 25 mass % of at least one friction modifier; and
   8 mass % to 45 mass % of at least one functional filler; and
(ii) a second mixture that includes:
   13 mass % to 25 mass % of at least one inert filler; and
   3 mass % to 15 mass % of at least one binder,
wherein the mass % of each component is with respect to the total mass of the friction material composition.

The mass ratio of the first mixture to the second mixture is in the range of 1:0.1 to 1:0.5. In an exemplary embodiment of the present disclosure, the mass ratio of the first mixture to the second mixture is 1:0.4.

The fibrous material can be at least one selected from the group consisting of rockwool fibers, polyacrylonitrile (PAN) fibers, aramid fibers, glass fibers, carbon fibers, polyester fibers, polyimide fibers and wollastonite fibers. In an exemplary embodiment of the present disclosure, the fibrous material is a combination of rockwool, polyacrylonitrile fibers and aramid fibers.

The friction modifier can be at least one selected from the group consisting of zircon, natural graphite, silicon carbide, zirconium silicate, alumina, silica, mullite, tin sulphide and petroleum coke. In an exemplary embodiment of the present disclosure, the friction modifier is a combination of zircon and natural graphite.

The functional fillers can be at least one selected from the group consisting of synthetic hydrated calcium silicate (Promaxon-D), potassium titanate, stainless steel particles 410, vermiculite, mica, attapulgite, talc, molybdenum trioxide, kaolin, flyash and hexagonal boron nitride. In an exemplary embodiment of the present disclosure, the functional filler is a combination of synthetic hydrated calcium silicate (Promaxon-D), potassium titanate, stainless steel particles 410 and vermiculite.

The inert filler in the second mixture in accordance with the present disclosure is at least one selected from the group consisting of barite and calcium carbonate. In an exemplary embodiment of the present disclosure, the inert filler is barite.

The binder can be at least one selected from the group consisting of reactive poly aryl ether ketone (R-PAEK), polybenzoxazine resin, thermosetting polymer such as phenolic resin and epoxy resin. In an exemplary embodiment of the present disclosure, the binder is poly aryl ether ketone (R-PAEK).

The reactive poly aryl ether ketone (R-PAEK) has a particle size (D50) in the range of 5 microns to 60 microns. In an exemplary embodiment of the present disclosure, the reactive poly aryl ether ketone (R-PAEK) has a particle size (D50) of 13 microns.

The reactive poly aryl ether ketone (R-PAEK) in accordance with the present disclosure has a molecular weight in the range of 55,000 to 70,000.

The reactive polyarylether ketone (R-PAEK) binder has a long shelf-life, superior thermal and mechanical properties at elevated temperatures such as high modulus, strength, and toughness as well as chemical inertness as compared to the conventional phenolic resins used in friction materials. Further, unlike the conventional phenolic resins the reactive polyarylether ketone (R-PAEK) binder does not emit noxious volatile by-products such as formaldehyde, ammonia, and the like during molding thereby, avoiding environmental issues as well as cracks and voids in the molded product. Still further, the binder R-PAEK is thermally stable and does not require a post-curing process after compression molding, allowing for better processability and productivity.

R-PAEK is a polymerized product of p, p′-hydroxy, chloro-benzophenone (CHBP) with a high glass transition temperature of 165° C. and melting temperature of 371° C.

In an embodiment of the present disclosure, the amounts of the ingredients of the first mixture are kept constant and the amounts of the ingredients of the second mixture are varied. In an exemplary embodiment of the present disclosure, the amount of the first mixture is 72 mass % and the amount of the second mixture is 28 mass %.

In accordance with the exemplary embodiment of the present disclosure, the amounts of the ingredients (inert filler and binder) of the second mixture are varied as given in the below table.

| Ingredients | Friction | Friction | Friction | Friction | Friction |
|---|---|---|---|---|---|
| of the | material | material | material | material | material |
| second | compo- | compo- | compo- | compo- | compo- |
| mixture | sition- | sition- | sition- | sition- | sition- |
| (mass %) | 1 | 2 | 3 | 4 | 5 |
| R-PAEK | 4 | 6 | 8 | 10 | 12 |
| Barite | 24 | 22 | 20 | 18 | 16 |

The amount of R-PAEK binder in the range of 4 mass % to 6 mass % allows for an optimal combination of performance characteristics such as reduced friction sensitivity to speed, pressure and temperature; high wear resistance and lower noise-vibration levels. When processing the brake pads made up of conventional phenolic resins need 3 to 8 hours of post-curing time to complete the curing process after molding. By eliminating the curing step in the brake pads made up of R-PAEK resins, significant energy and time savings are achieved.

In a second aspect, the present disclosure provides a process for the preparation of a friction material composition. The process comprises the following steps:
(i) mixing at least one fibrous material with at least one inert filler at a first predetermined stirring speed for a first predetermined time period to obtain a first mixture;
(ii) separately, mixing at least one friction modifier, at least one functional filler and at least one binder at a second predetermined stirring speed for a second predetermined time period to obtain a second mixture;
(iii) mixing the first mixture and the second mixture at a third predetermined stirring speed for a third predetermined time period to obtain the friction material composition.

The process for the preparation of a friction material composition is described in detail herein below.

In a first step, at least one fibrous material is mixed with at least one inert filler at a first predetermined stirring speed for a first predetermined time period to obtain a first mixture.

The fibrous material can be at least one selected from the group consisting of rockwool fibers, polyacrylonitrile (PAN) fibers, aramid fibers, glass fibers, carbon fibers, polyester fibers, polyimide fibers and wollastonite fibers. In an exemplary embodiment of the present disclosure, the fibrous material is a combination of rockwool, polyacrylonitrile fibers and aramid fibers.

The inert filler in the second mixture in accordance with the present disclosure is at least one selected from the group consisting of barite and calcium carbonate. In an exemplary embodiment of the present disclosure, the inert filler is barite.

In accordance with the present disclosure, the first predetermined stirring speed is in the range of 200 rpm to 400 rpm. In an exemplary embodiment of the present disclosure, the first predetermined stirring speed is 250 rpm.

In accordance with the present disclosure, the first predetermined time period is in the range of 2 minutes to 25 minutes. In an embodiment of the present disclosure, the first predetermined time period is 21 minutes.

In a second step, separately, at least one friction modifier is mixed with at least one functional filler and at least one binder at a second predetermined stirring speed for a second predetermined time period to obtain a second mixture.

The friction modifier can be at least one selected from the group consisting of zircon, natural graphite, silicon carbide, zirconium silicate, alumina, silica, mullite, tin sulphide and petroleum coke. In an exemplary embodiment of the present disclosure, the friction modifier is a combination of zircon and natural graphite.

The functional fillers can be at least one selected from the group consisting of synthetic hydrated calcium silicate (Promaxon-D), potassium titanate, stainless steel particles 410, vermiculite, mica, attapulgite, talc, molybdenum trioxide, kaolin, flyash and hexagonal boron nitride. In an exemplary embodiment of the present disclosure, the functional filler is a combination of synthetic hydrated calcium silicate (Promaxon-D), potassium titanate, stainless steel particles 410 and vermiculite.

The binder can be at least one selected from the group consisting of reactive poly aryl ether ketone (R-PAEK), polybenzoxazine resin, thermosetting polymer such as phenolic resin and epoxy resin. In an exemplary embodiment of the present disclosure, the binder is poly aryl ether ketone (R-PAEK).

In accordance with the present disclosure, the second predetermined stirring speed is in the range of 200 rpm to 400 rpm. In an exemplary embodiment of the present disclosure, the second predetermined stirring speed is 280 rpm.

In accordance with the present disclosure, the second predetermined time period is in the range of 1 minute to 5 minutes. In accordance with an embodiment of the present disclosure, the first predetermined time period is 4 minutes.

In a third step, the first mixture is mixed with the second mixture at a third predetermined stirring speed for a third predetermined time period to obtain the friction material composition.

In accordance with the present disclosure, the third pre-determined stirring speed is in the range of 2500 rpm to 3000 rpm. In an exemplary embodiment of the present disclosure, the third pre-determined stirring speed is 2800 rpm.

In accordance with the present disclosure, the third predetermined time period is in the range of 1 minute to 10 minutes. In an exemplary embodiment of the present disclosure, the third predetermined time period is 2 minutes.

In a third aspect, the present disclosure provides a process for the fabrication of an article by using the friction material composition.

The process comprises the step of drying the friction material composition at a temperature in the range of 60° C. to 90° C. to obtain a dried friction material composition. The dried friction material composition is preformed at a pressure in the range of 1 MPa to 3 MPa to obtain at least one preform. The preform is placed into a mold cavity followed by heating to a temperature in the range of 400° C. to 450° C. for a time period in the range of 2 minutes to 10 minutes to obtain a heated preform, wherein the mold cavity is fixed into a compression molding machine and preloaded with adhesive-applied backplates. A pressure in the range of 80 bars to 120 bars with 5 cycles of intermittent breathings is applied to the heated preform for a time period in the range of 5 hours to 10 hours to obtain a fabricated article. The fabricated article is cooled to a temperature in the range of 20° C. to 30° C. followed by removing the fabricated article from the mold cavity.

In an exemplary embodiment of the present disclosure, the process for the fabrication of an article comprises the step of drying the friction material composition at 80° C. to obtain a dried friction material composition. The dried friction material composition is preformed at a pressure of 2 MPa to obtain two preforms. These two preforms are placed into a mold cavity (two-cavity mold) followed by heating to a temperature of 420° C. for 5 minutes to obtain heated preforms, wherein the mold cavity is fixed into a compression molding machine and preloaded with adhesive-applied backplates. A pressure of 100 bars with 5 cycles of intermittent breathings is applied to the heated preforms for 8 hours to obtain a fabricated article. The fabricated article is cooled to 25° C. followed by removing the fabricated article from the mold cavity.

The present disclosure provides a non-asbestos organic (NAO) and copper-free friction material composition with R-PAEK as binder which is used in making brake pads, shoes, clutch facing brake blocks and other friction material composition products for trains or industrial machinery due to its lower sensitivity to operating parameters such as speed, pressure, and temperature and increased wear resistance.

As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

The foregoing description of the embodiments has been provided for purposes of illustration and is not intended to limit the scope of the present disclosure. Individual components of a particular embodiment are generally not limited to that particular embodiment but are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to the industrial scale.

### EXPERIMENTAL DETAILS

### Experiment 1: Preparation of Friction Material Compositions Using Reactive Poly Aryl Ether Ketone (R-PAEK) as Binder in Accordance with the Present Disclosure

### Example 1: Preparation of Friction Material Composition by Using 4 Mass % of R-PAEK and 24 Mass % of Barite

30 g of aramid pulp was stirred for 7 minutes at 250 rpm to obtain a homogeneous aramid pulp. 240 g of barite was added to the homogeneous aramid pulp and stirred at 250 rpm for 5 minutes to obtain a first homogeneous blend. 30 g of polyacrylonitrile (PAN) was added to the first homogeneous blend and stirred at 250 rpm for 5 minutes to obtain a second homogeneous blend. 100 g of rockwool (RB250) was added to the second homogeneous blend and stirred at 250 rpm for 4 minutes to obtain a first mixture.

Separately, 100 g of natural graphite, 60 g of zircon, 80 g of vermiculite, 120 g of potassium titanate, and 100 g of stainless-steel powder (SS 410), 100 g of Promaxon D and 40 g of R-PAEK binder were mixed and stirred at 280 rpm for 4 minutes to obtain a second mixture.

The so obtained first mixture and the second mixture were mixed at 2800 rpm for 2 minutes to obtain the friction material composition-1.

### Examples 2-5: Preparation of Friction Material Compositions-2 to 5 by Varying the Amounts of R-PAEK and Barite

The same procedure was followed as in example 1 except that varying amounts of R-PAEK and barite were used as disclosed in Table 1 below.

### Comparative Example: Preparation of Friction Material Composition by Using Phenolic Resin

The same procedure was followed as in example 1 except that 8 g of phenolic resin (binder) and 20 g of barite were used to obtain the friction material composition-6.

TABLE 1
Preparation of friction material compositions-1 to 6 by
varying the amounts of R-PAEK/phenolic resin and barite

| | Friction | Friction | Friction | Friction | Friction | Friction material |
|---|---|---|---|---|---|---|
| Ingredients of | material | material | material | material | material | composition -6 |
| the second | composi- | composi- | composi- | composi- | composi- | (Comparative |
| mixture (g) | tion -1 | tion -2 | tion -3 | tion -4 | tion -5 | example) |
| R-PAEK | 4 | 6 | 8 | 10 | 12 | 0 |
| Phenolic resin | 0 | 0 | 0 | 0 | 0 | 8 |
| Barite | 24 | 22 | 20 | 18 | 16 | 20 |

Fixed ingredients (first mixture) 72 mass %: variable ingredients (second mixture) 28 mass %

### Experiment 2: Fabrication of Backplates (Preparation of Brake Pads) by Using the Friction Material Compositions 1-6 Prepared in Experiment 1

### Example A: Preparation of Brake Pad-1 by Using the Friction Material Composition-1

The friction material composition-1 obtained in example 1 was dried at 80° C. to obtain a dried friction material composition. 65 g of the dried friction material composition was preformed in a performer by applying manual pressure of 2 MPa to obtain two preforms. The so obtained preforms were placed into a mold cavity (two-cavity mold) which was fixed into a compression molding machine and preloaded with adhesive-applied backplates. The temperature of the mold was increased and as the mold temperature reached at 420° C., the pressure was applied with 5 cycles of intermittent breathings, followed by the final application of pressure of 100 bars. The pressure was maintained for 8 hours whereas the temperature of 420° C. was maintained only for the first 5 minutes and then heating was stopped to obtain a fabricated article. After 8 hours, the cooled brake pads were manually removed from the mold cavity. Since R-PAEK resin based friction material composition does not need post-curing, it was directly used for surface polishing, grinding, and subsequent characterization.

### Example B-E: Preparation of Brake Pads-2 to 5 by Using the Friction Material Compositions-2 to 5 Prepared in Experiment 1 Respectively

The same procedure as in Example A was followed except using the friction material compositions-2 to 5 of Examples 2 to 5 to obtain the brake pads-2 to 5 respectively.

### Example F: Preparation of Brake Pad-6 by Using the Friction Material Composition-6 Prepared in Experiment 1

The phenolic resin based friction material composition-6 prepared in Experiment 1 is preformed and cold pressed into brake pads and then heated in an oven at 75° C. for 30 minutes to remove moisture and prevent cracks during hot compression molding. The brake pad was cured for 9 minutes at a pressure of 140 bar and at 165° C. to obtain a semi-cured brake pad. The semi-cured brake pad was further cured in an oven at 120° C. for 2 hours and further at 160° C. for 5 hours to obtain a cured brake pad-6. Post-cured brake pad-6 was further used for characterization.

### Experiment 3: Annealing Studies of R-PAEK Based Brake Pad-3 Prepared in Example-C of Experiment 2

The annealing studies of the R-PAEK based brake pad-3 prepared in Example-C of Experiment 2 were carried out at a temperature range of 400° C. to 420° C. with 30 minutes interval for 5 hours. The hardness of so obtained annealed sample was measured six times at different locations on the pad using the Rockwell hardness (HRR) test, and the average values were recorded. It was found that after complete curing, the hardness of the R-PAEK based brake pad-3 did not increase further. The annealing treatment time showed no significant difference in the hardness, and hence it was confirmed that the R-PAEK based brake pads prepared by using the friction material composition of the present disclosure did not need any further post-curing.

### Experiment 5: Characterization of R-PAEK Resin and the Phenolic Resin

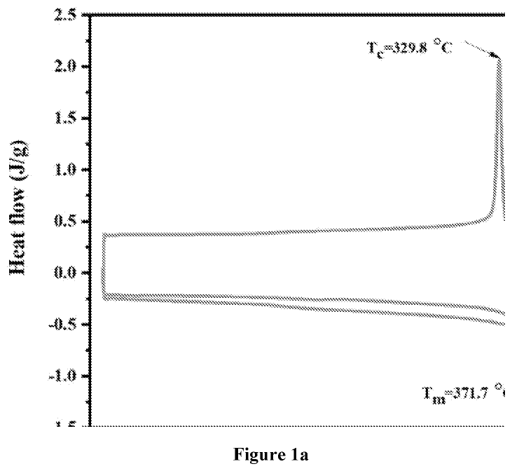

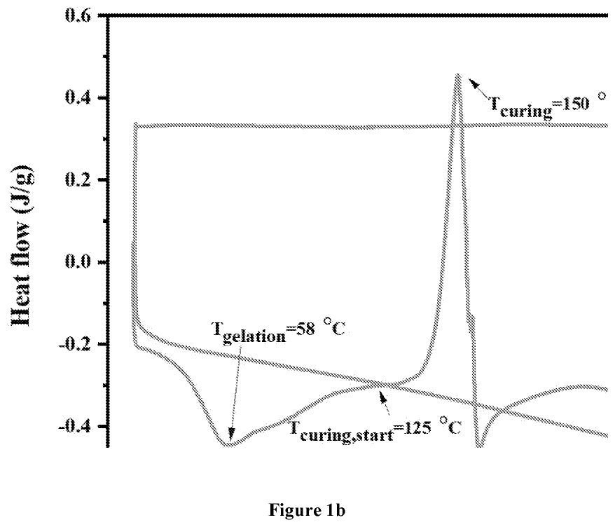

R-PAEK resin and traditional Phenolic resin were characterized for curing, gelation, melting and crystallization behaviour with the help of DSC (DAS Q 200 by TA Instruments) under N₂ environment (FIGS. 1a and 1b). The heat flow was measured for the temperature range of 40° C. to 400° C. for the R-PAEK resin and 40° C. to 250° C. for a phenolic resin at a heating rate/cooling rate of 10° C./minute. The samples were heated up to 250° C./400° C. and held for 5 minutes at 250° C./400° C. to erase the thermal history in the sample followed by cooling up to 40° C. with a cooling rate of 10° C./min and further heated to 250° C./400° C. with a heating rate of 10° C./min. The melting, crystallization, and curing behaviour of samples were determined by the second and third scans.

Tₘ 372° C. for R-PAEK resin was determined by DSC scan as shown in FIG. 1a, therefore, molding was performed at 40° C. to 50° C. higher to the temperature of 372° C. However, as shown in FIG. 1b, the maximum curing temperature of phenolic resin is 150° C. Thus, the molding was done at 160-165° C.

### Experiment 6: Characterization of R-PAEK Resin Based Brake Pads-1 to 5 and the Phenolic Resin Based Braked Pad-6

The brake pads prepared in Experiment 2 in accordance with the present disclosure were evaluated on the following aspects:
A. Physical, mechanical, and chemical characteristics such as density, porosity, hardness, compressibility, shear strength and
B. Tribological characteristics of the friction material composition on full scale dynamometer.

### A. Physical, Mechanical, and Chemical Characteristics

For density measurement, the pads prepared in Experiment 2 were weighed and coated with M-seal so that porosity would be zero when dipped in water and evaluated by using Archimedes' principle and Porosity (both oil and water) according to the JIS D4418 standard. The hardness was measured on the Rockwell hardness tester as per ASTM D785. The shear strength was evaluated as per ISO 6312:2010 standard. The compressibility test was carried out as per ISO 6310 standard. The thermal conductivity of brake pads measured as per ASTM E1530-11 standard based on a guarded heat flow meter.

The results are summarized in Table 2 below:

TABLE 2
Physical, mechanical and chemical characterization of R-PAEK
based brake pads-1 to 5 and phenolic resin based brake pad-6

| | | | | | | | | Phenolic |
|---|---|---|---|---|---|---|---|---|
| | | | Brake | Brake | Brake | Brake | Brake | resin based |
| Standard | Property | Unit | pad-1 | pad-2 | pad-3 | pad-4 | pad-5 | Brake pad-6 |
| SAE J380 | Density (ρ) | g/cc | 2.45 | 2.35 | 2.26 | 2.17 | 2.09 | 2.23 |
| JIS D4418 | Water | % | 14.01 | 12.60 | 9.63 | 8.72 | 7.17 | 10.43 |
| | porosity | | | | | | | |
| JIS D4418 | Oil | % | 11.49 | 10.61 | 8.25 | 6.75 | 5.89 | 9.34 |
| | porosity | | | | | | | |
| ASTM | Hardness | HRR | 101 | 105 | 113 | 114 | 116 | 104 |
| D785 | | | | | | | | |
| ISO 6310 | Compress- | μm | 79 | 68 | 40 | 34 | 29 | 54 |
| | ibility | | | | | | | |
| ISO 6312 | Shear | kgf/cm2 | — | — | 40 | — | — | 35 |
| | strength | | | | | | | |
| ASTM | Thermal | W/mK | 0.48 | 0.52 | 0.48 | 0.41 | 0.44 | 0.43 |
| E1530-11 | conductivity | | | | | | | |

The density, oil porosity and water porosity of R-PAEK based brake pads-1 to 5 decreased with an increase in binder content. The increasing R-PAEK contents of the friction material composition led to higher hardness, higher thermal conductivity, and lower compressibility. Phenolic resin based brake pad-6 (prepared conventionally) showed the lower density, lower hardness, lower compressibility, and lower shear strength compared to R-PAEK pads for identical formulation. Additionally, the conventional Phenolic brake pads showed lower porosity and thermal conductivity compared to R-PAEK pads for the same formulation.

### B. Tribological Characteristics:

The tribological test was carried out on a full-scale brake inertia dynamometer against the Maruti SuzukiAlto™ disc following the Japanese Automotive Standards Organization (JASO) C406:2000 standard. The relative humidity level was around 50-55% RH, and the ambient temperature was 25-30° C.

The brake pads fabricated according to Experiment 2 of the present disclosure were subjected to the following tribological tests:

The full-scale inertia dynamometer test is compliant with the JASO 406C standard. It includes two cycles: effectiveness cycles, and fade and recovery cycles. These are the two modules of the test which describe the most vital properties of brake materials. The effectiveness cycle was used to simulate the effect of speed and pressure on friction, thereby determining the average friction coefficient, and average u (average of all effectiveness cycles). The fade and recovery cycle was used to simulate the effect of temperature or higher energy on the brakes thereby deriving the % fade ratio and recovery ratio.

The comparison between the tribological tests of R-PAEK based brake pads-1 to 5 prepared in accordance with the present disclosure and phenolic resin based brake pad-6 are shown in Table 3 below.

In the tribological test, the % speed spread (% SS) was calculated by the formula (1).

$$\% SS = ( {μ}_{h i gher speed} / {μ}_{lower speed} ) \qquad ( 1 )$$

In the above tribological test, the % fade ratio (% FR) or % recovery ratio (% RR) was calculated by the formula (2) and the results are shown in Table 3.

$$\% FR or \% RR = ( \frac{{μ}_{min}}{{μ}_{max}} \times 100 ) \qquad ( 2 )$$

Where μₘᵢₙ=lowest u observed during fade/recovery cycle; μₘₐₓ=highest u observed during the fade/recovery cycle.

Maximum disc temperature (MDT) was utilized to measure disc friendliness and was defined as maximum disc temperature rise throughout fade and recovery cycles.

The weight change of the pair of brake pads is used to determine the wear volume, which is defined as the ratio of the brake pad weight change to the brake pad density and is used to indicate the wear resistance of pads.

TABLE 3
Physical, mechanical and chemical characterization of R-PAEK
based brake pads-1 to 5 and phenolic resin based brake pad-6

| | | | | | | | % ↑ or ↓ | % ↑ or ↓ | |
|---|---|---|---|---|---|---|---|---|---|
| | | | | | | | (Comparison | (Comparison | |
| | | | | | | | with Brake | with Brake | |
| | Brake | Brake | Brake | Brake | Brake | Brake | pad-1-Brake | pad-3-Brake | Comment |
| Properties | pad-1 | pad-2 | pad-3 | pad-4 | pad-5 | pad-6 | pad- 6) | pad-6) | Favouring |
| Average μ | 0.34 | 0.33 | 0.33 | 0.32 | 0.31 | 0.32 | 6.25 | 3.12 | industrial |
| | | | | | | | | | range 0.30 to |
| | | | | | | | | | 0.45 |
| %SS# (↑) | 86.46 | 85.9 | 88.74 | 86.84 | 88.98 | 84.06 | 2.85 | 5.56 | Pad3 > Pad1 > |
| | | | | | | | | | Pad6 |
| FR (%) (↑) | 42.83 | 37.8 | 34.2 | 31.0 | 30.1 | 36.91 | 16.00 | −7.23 | Pad1 > Pad3 > |
| | | | | | | | | | Pad6 |
| RR (%) (↑) | 92.83 | 87.8 | 89.4 | 88.70 | 87.07 | 88.02 | 5.46 | 1.57 | ↑-Reduced the |
| | | | | | | | | | sensitivity |
| | | | | | | | | | towards speed. |
| MDT(° C.) | 386 | 366 | 356 | 345 | 333 | 411 | −6.08 | −13.38 | Pad1 >> Pad6 > |
| (↓) | | | | | | | | | Pad3 |
| Wear | 2.50 | 3.05 | 3.45 | 4.75 | 5.75 | 2.80 | −10.71 | 23.21 | ↑-beneficial at |
| (cm3) (↓) | | | | | | | | | harsh braking |

Note:
−ve sign indicates % decrement;
↑ shows higher the better;
↓ shows lower the better;
#Severe condition

From Table 3 it is observed that the friction material composition containing the R-PAEK binder has a higher or similar average u compared to the conventional friction material composition based on phenolic resin. All tribological properties such as average μ—6.25% higher, Sensitivity of μ to speed—3% lower, Sensitivity of μ to temperature—16% lower, Tendency to recover the—5% higher, counterface friendliness—6% higher and wear—11% lower, for friction material compositions with 4 wt. % R-PAEK binder compared to phenolic-based brake pads. The overall tribological performance is improved by adding R-PAEK powder as a binder in the friction material composition prepared in accordance with the present disclosure.

Tables 2 and 3 show that 4 mass % R-PAEK binder prepared in accordance with the present disclosure outperforms phenolic resin based brake pads in terms of overall performance i.e. 4 mass % of R-PAEK based brake pads prepared in accordance with the present disclosure was found to be the optimum amount for the best combination of performance properties like reduced friction sensitivity to speed, pressure, and temperature, high wear resistance, and lower noise-vibration levels. As a result, the friction material compositions with R-PAEK binder prepared in accordance with the present disclosure provides a replacement for friction material compositions with phenolic resin with improved tribological performance. The friction material compositions with R-PAEK binder have longer shelf life and do not evolve noxious by-products during curing.

Therefore, the brake pads using R-PAEK as binder prepared in accordance with the present disclosure have superior physical, mechanical, and chemical characteristics as well as tribological characteristics.

### TECHNICAL ADVANCEMENTS

The present disclosure described hereinabove has several technical advantages including, but not limited to, the realization of a friction material composition comprising reactive polyaryl ether ketone (R-PAEK) binder that:
does not require post curing to make brake pads;
does not produce volatiles on molding at high temperatures thereby avoiding cracks and voids in molded products;
has longer shelf life and do not evolve noxious by-products; and
has superior physical and tribological properties.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values given for various physical parameters, dimensions, and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A friction material composition comprising:
(i) a first mixture that includes;
2 mass % to 25 mass % of at least one fibrous material;
2 mass % to 25 mass % of at least one friction modifier; and
8 mass % to 45 mass % of at least one functional filler; and
(ii) a second mixture that includes;
13 mass % to 25 mass % of at least one inert filler; and
3 mass % to 15 mass % of at least one binder,
wherein a mass ratio of said first mixture to said second mixture is in the range of 1:0.1 to 1:0.5,
wherein said mass % of each component is with respect to the total mass of said friction material.

2. The friction material composition as claimed in claim 1, wherein said fibrous material is at least one selected from the group consisting of rockwool fibers, polyacrylonitrile (PAN) fibers, aramid fibers, glass fibers, carbon fibers, polyester fibers, polyimide fibers and wollastonite fibers.

3. The friction material composition as claimed in claim 1, wherein said friction modifier is at least one selected from the group consisting of zircon, natural graphite, silicon carbide, zirconium silicate, alumina, silica, mullite, tin sulphide and petroleum coke.

4. The friction material composition as claimed in claim 1, wherein said functional filler is at least one selected from the group consisting of synthetic hydrated calcium silicate (Promaxon-D), potassium titanate, stainless steel particles 410, vermiculite, mica, attapulgite, talc, molybdenum trioxide, kaolin, flyash and hexagonal boron nitride.

5. The friction material composition as claimed in claim 1, wherein said inert filler is at least one selected from the group consisting of barite and calcium carbonate.

6. The friction material composition as claimed in claim 1, wherein said binder is at least one selected from the group consisting of reactive poly aryl ether ketone (R-PAEK), polybenzoxazine resin, thermosetting polymer such as phenolic resin and epoxy resin.

7. The friction material composition as claimed in claim 6, wherein said reactive poly aryl ether ketone (R-PAEK) has a particle size (D50) in the range of 5 microns to 60 microns.

8. A process for the preparation of a friction material composition, said process comprising the following steps:
(i) mixing at least one fibrous material with at least one inert filler at a first predetermined stirring speed for a first predetermined time period to obtain a first mixture;
(ii) separately, mixing at least one friction modifier, at least one functional filler and at least one binder at a second predetermined stirring speed for a second predetermined time period to obtain a second mixture; and
(iii) mixing said first mixture and said second mixture at a third predetermined stirring speed for a third predetermined time period to obtain said friction material composition.

9. The process as claimed in claim 8, wherein said fibrous material is at least one selected from the group consisting of rockwool fibers, polyacrylonitrile (PAN) fibers, aramid fibers, glass fibers, carbon fibers, polyester fibers, polyimide fibers and wollastonite fibers.

10. The process as claimed in claim 8, wherein said inert filler is at least one selected from the group consisting of barite and calcium carbonate.

11. The process as claimed in claim 8, wherein said first and said second predetermined stirring speed is independently in the range of 200 rpm to 400 rpm.

12. The process as claimed in claim 8, wherein said first predetermined time period is in the range of 2 minutes to 25 minutes.

13. The process as claimed in claim 8, wherein said friction modifier is at least one selected from the group consisting of zircon, natural graphite, silicon carbide, zirconium silicate, alumina, silica, mullite, tin sulphide and petroleum coke.

14. The process as claimed in claim 8, wherein said functional filler is at least one selected from the group consisting of synthetic hydrated calcium silicate (Promaxon-D), potassium titanate, stainless steel particles 410, vermiculite, mica, attapulgite, talc, molybdenum trioxide, kaolin, flyash and hexagonal boron nitride.

15. The process as claimed in claim 8, wherein said binder is at least one selected from the group consisting of reactive poly aryl ether ketone (R-PAEK), polybenzoxazine resin, thermosetting polymer such as phenolic resin and epoxy resin.

16. The process as claimed in claim 15, wherein said reactive poly aryl ether ketone (R-PAEK) has a particle size (D50) in the range of 5 microns to 60 microns.

17. The process as claimed in claim 8, wherein said second predetermined time period and said third predetermined time period is independently in the range of 2 minutes to 10 minutes.

18. The process as claimed in claim 8, wherein said third predetermined stirring speed is in the range of 2500 rpm to 3000 rpm.

19. A process for the fabrication of an article by using said friction material composition as claimed in claim 1, said process comprising the following steps:
a. drying said friction material composition at a temperature in the range of 60° C. to 90° C. to obtain a dried friction material composition;
b. preforming said dried friction material composition at a pressure in the range of 1 MPa to 3 MPa to obtain at least one preform;
c. placing said preform into a mold cavity followed by heating to a temperature in the range of 400° C. to 450° C. for a time period in the range of 2 minutes to 10 minutes to obtain a heated preform,
wherein said mold cavity is fixed into a compression molding machine and preloaded with adhesive-applied backplates,
d. applying a pressure in the range of 80 bars to 120 bars with 5 cycles of intermittent breathings to said heated preform for a time period in the range of 5 hours to 10 hours to obtain a fabricated article; and
e. cooling said fabricated article to a temperature in the range of 20° C. to 30° C. followed by removing said fabricated article from said mold cavity.
